(19) United States
(12) Patent Application Publication
(10) Pub. No.: US 2025/0387957 A1
(43) Pub. Date: Dec. 25, 2025

(54) MOLDED BODY AND METHOD FOR MOLDING MOLDED BODY

(71) Applicant: TOKAI CHEMICAL INDUSTRIES, LTD., Gifu (JP)

(72) Inventors: Takahiro Kawada, Gifu (JP); Yukihiro Sakashita, Gifu (JP); Hiroshi Koide, Gifu (JP); Yasuo Suzuki, Gifu (JP)

(73) Assignee: TOKAI CHEMICAL INDUSTRIES, LTD., Gifu (JP)

(21) Appl. No.: 19/315,842

(22) Filed: Sep. 1, 2025

Related U.S. Application Data
(63) Continuation of application No. PCT/JP2024/008117, filed on Mar. 4, 2024.

(30) Foreign Application Priority Data
Mar. 14, 2023 (JP) 2023-040021

(51) Int. Cl. B29C 45/14; B29C 33/42; B29C 45/26

(52) U.S. Cl. CPC B29C 45/14; B29C 33/42; B29C 45/26

(57) ABSTRACT

A molded body includes: a plate-like base material which is formed of a resin material and in which one surface in the thickness direction serves as a convex surface and the other surface serves as a concave surface; an inner layer which is formed of urethane and covers at least the convex surface of the base material; and an outer layer which is formed of a coating material and covers at least the coating region of the convex surface of the inner layer. The molded body is attached to an attachment target member with the convex surface facing outward. On a left end part of the base material, an undercut part is formed by injection molding in an inner layer that covers the left end part, and the outer layer covers up to the undercut part.

### CROSS-REFERENCE TO RELATED APPLICATION

This application is a continuation of PCT International Application No. PCT/JP2024/008117, filed on Mar. 4, 2024, which claims priority under 35 U.S.C § 119 (a) to Japanese Patent Application No. 2023-040021, filed on Mar. 14, 2023. Each of the above application(s) is hereby expressly incorporated by reference, in its entirety, into the present application.

### BACKGROUND

### Technical Field

The disclosure relates to a molded body made of a resin material and a method for molding the molded body.

### Description of Related Art

A molded body made of a resin material is formed by injection molding the resin material into a mold, for example, like RIM molding. In particular, a skin (outer layer) made of a coating material may be formed on the surface of the molded body for coloring. As a method for forming such a skin, for example, Patent Literature 1 (Japanese Patent Application Laid-Open No. 11-77739) discloses an integrated molding method in which a pre-molded skin is placed in a mold, a resin material is injected into a cavity formed between the skin and the mold surface, and then compressed to integrally mold the skin and the resin core.

However, the integrated molding method, in addition to requiring an extra molding process for the skin and separate molds, is unable to accommodate when the shape of the molded body becomes complex. Therefore, as another method, in-mold coating is also known, in which an outer resin material that becomes the skin is applied to the inner surface of the mold, and then inner resin material is injected into the cavity for transfer. In this case, since molding and coating can be performed in the same mold, the process and cost can be reduced, and the method is able to accommodate even when the shape of the molded body is complex.

FIGS. 3A to 3C show an example of molding by in-mold coating. When the molded body is a plate-shaped form with one surface in a thickness direction being a convex surface and the other surface being a concave surface, with the convex surface becoming the outer surface, such as a door armrest of automotive interior parts, the mold is divided into an upper die 50 and a lower die 60 as shown in FIG. 3A. The upper die 50 is provided with a pair of upper mating surfaces 51A and 51B and an inner forming surface 52 that is protruded between the upper mating surfaces 51A and 51B and corresponds to the concave surface of the molded body. The lower die 60 is provided with a pair of lower mating surfaces 61A and 61B and an outer forming surface 62 that is recessed between the lower mating surfaces 61A and 61B and corresponds to the convex surface of the molded body.

In the case of molding an inner layer made of urethane and an outer layer made of a coating material by in-mold coating using the upper die 50 and the lower die 60, in the lower die 60, a coating material 63 is applied in advance to the outer forming surface 62 and the lower mating surfaces 61A and 61B. In the upper die 50, since there is a need to color the parts visible from the outside, the inner layer and outer layer are formed on the surface of the base material and on both ends of the back side thereof as well. Therefore, since concave parts 53 and 53 that form a part of the cavity are formed on both ends of the back side on the inner forming surface 52 of the upper die 50, a coating material 54 is applied in advance to the upper mating surfaces 51A and 51B and the concave parts 53 and 53 on both ends as well.

Next, as shown in FIG. 3B, mold matching is performed with a base material 70 fixed to the inner forming surface 52 of the upper die 50, and urethane is injection molded in a cavity 71 formed between the upper die 50 and the lower die 60. Then, as shown in FIG. 3C, a molded body 80 is obtained in which an inner layer 72 made of urethane and an outer layer 73 formed by the transfer of the coating materials 54 and 63 are integrally molded from the surface of the base material 70 to the back sides of both ends.

The molded body 80 is attached in a state where both ends are in contact with or close to an attachment target member 41. Therefore, merely the outer layer 73 is exposed to the exterior.

However, in the molding using the above in-mold coating, a split line (parting line) PL between the upper die 50 and the lower die 60 occurs on the surface of the outer layer 73. Therefore, the appearance becomes poor and is impaired. In addition, since it is needed to form the outer layer 73 in a region visible from the outside, the coating materials 54 and 63 need to be applied to both the upper die 50 and the lower die 60, leading to an increase in the coating process and the usage amount of the coating material, resulting in an increase in the manufacturing process and cost increase.

Therefore, the disclosure provides a molded product and a method for molding the same that can prevent deterioration of appearance due to a parting line and improve designability even when an outer layer formed by a coating material is formed on a surface by in-mold coating, and to shorten the manufacturing process and reduce cost.

### SUMMARY

A first configuration of the disclosure is a molded body that includes a plate-like base material which is formed of a resin material, and in which one surface in a thickness direction is a convex surface and the other surface is a concave surface, an inner layer which is formed of a second resin material and covers at least the convex surface of the base material, and an outer layer which is formed of a third resin material and covers at least a coating region of the convex surface of the inner layer, the molded body is attached to an attachment target member with the convex surface facing outward,
at either one of both end parts of the base material in a direction intersecting with the thickness direction, an undercut part is formed by injection molding in the inner layer covering the end part, and
the outer layer covers at least up to the undercut part.

Another aspect of the first configuration is that, in the above configuration, a parting line is formed at an end part on the concave surface side of the undercut part in the inner layer, and the outer layer covers up to a position of the parting line.

Another aspect of the first configuration is that, in the above configuration, the parting line is positioned to be hidden by the attachment target member when attached to the attachment target member.

Another aspect of the first configuration is that, in the above configuration, the inner layer covering the other end part of the base material is folded toward the concave surface side of the base material and covers the concave surface, a second parting line is formed at an end part of the inner layer covering the concave surface, and the outer layer is also folded toward the concave surface side of the base material and covers the concave surface up to a position of the second parting line.

A second configuration of the disclosure is a method for molding a molded body in which a first mold and a second mold are used, the first mold having a pair of first mating surfaces and an inner forming surface that protrudes in a mold matching direction from first inner edges of the pair of first mating surfaces and becomes an outer surface corresponding to a concave surface of the molded body, and
the second mold having a pair of second mating surfaces disposed to face the pair of first mating surfaces in the mold matching direction and an outer forming surface that is recessed in the mold matching direction from second inner edges of the pair of second mating surfaces and becomes an outer surface corresponding to a convex surface of the molded body,
an outer resin material is applied to the outer forming surface of the second mold, and
in a state where a plate-shaped base material formed of a resin material, with the outer forming surface side being a convex surface and the inner forming surface side is a concave surface, is fixed to the inner forming surface of the first mold, the first mold and the second mold are mold clamped, and an inner resin material is injected into a cavity formed between the inner forming surface and the outer forming surface to form a molded body in which an inner layer made of the inner resin material and an outer layer made of the outer resin material cover the convex surface of the base material.

Then, a predetermined region continuous with the second inner edge on either one of the second mating surface sides of the outer forming surface becomes an undercut part that protrudes toward the cavity side,
in a process of applying the outer resin material to the outer forming surface, the outer resin material is applied to the outer forming surface including the undercut part and to the one of the second mating surfaces continuous with the undercut part, and
after the molded body is taken out from the cavity, the outer layer is cut off at a position of the second inner edge or at a predetermined position of the one of the second mating surfaces continuous with the second inner edge.

Another aspect of the second configuration is that, in the above configuration, on the first mating surface side opposite to the undercut part in the inner forming surface, a first excess length forming part which extends beyond a formation region of the cavity and continues to the first inner edge is formed, and in the inner forming surface, a concave part in which an end part of the base material is disposed to form an end part of the cavity is formed,
on the second mating surface side opposite to the undercut part in the outer forming surface, a second excess length forming part which extends beyond the formation region of the cavity, continues to the second inner edge, and faces the first excess length forming part is formed,
in the process of applying the outer resin material to the outer forming surface, the outer resin material is also applied to the second excess length forming part, and
after the molded body is taken out from the cavity, end parts of the inner layer and the outer layer at the first excess length forming part side and at the second excess length forming part side are folded back to the concave surface side of the base material and fixed to the concave surface.

### BRIEF DESCRIPTION OF THE DRAWINGS

FIGS. 1A to 1C are cross-sectional descriptive diagrams showing a method for molding a molded body.

FIG. 2 is a cross-sectional descriptive diagram showing a state where the molded body is attached to the attachment target member.

FIGS. 3A to 3C are cross-sectional descriptive diagrams showing a conventional method for molding a molded body.

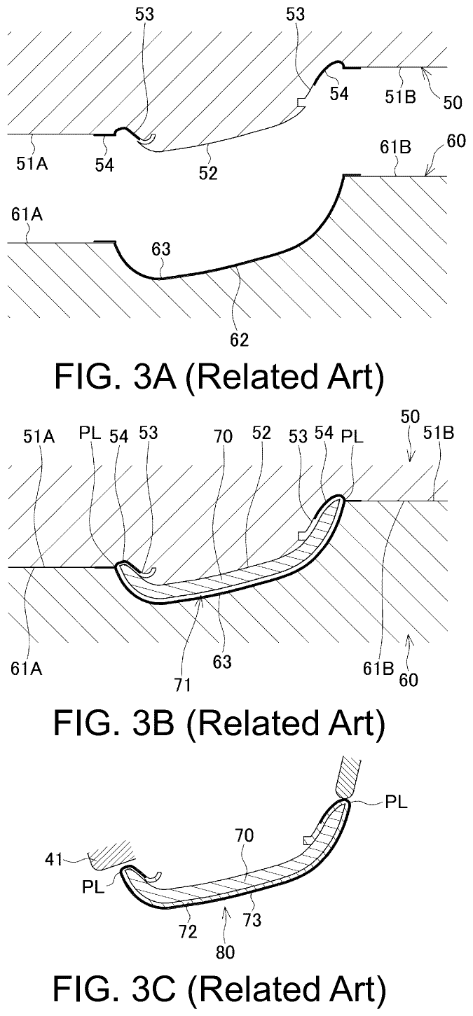

### DESCRIPTION OF EMBODIMENTS

According to the disclosure, even if the outer layer by the outer resin material is formed on the surface, deterioration of appearance due to the parting line may be prevented and designability may be improved. In addition, since the outer resin material merely needs to be applied to the second mold, the manufacturing process can be shortened and cost can be reduced.

According to another aspect of the first configuration, the parting line is formed at the end part on the concave surface side of the undercut part in the inner layer, and the outer layer covers up to the position of the parting line. Therefore, in addition to the above effect, the parting line becomes positioned close to the back side of the molded body, and is therefore less noticeable.

According to another aspect of the first configuration, the parting line is positioned to be hidden by the attachment target member when attached to the attachment target member. Therefore, in addition to the above effects, even if burrs occur at the parting line, burr treatment is unneeded or the finishing level of burr treatment can be simplified. As a result, the manufacturing process can be shortened.

According to another aspect of the first configuration, at the other end part side of the base material, the inner layer and the outer layer are folded toward the concave surface side of the base material, covering the concave surface up to the position of the second parting line. Therefore, in addition to the above effects, even without providing the undercut part in the second mold at the other end part side and shifting the parting line toward the concave surface side, the parting line can be hidden to the back side.

According to another aspect of the second configuration, the end parts of the inner layer and the outer layer at the first excess length forming part side and at the second excess length forming part side are folded back to the concave surface side of the base material and fixed to the concave surface. Therefore, in addition to the above effects, at the other end part side of the base material, the parting line can be hidden at a position unable to be seen from the outside.

The following describes embodiments of the disclosure based on the drawings.

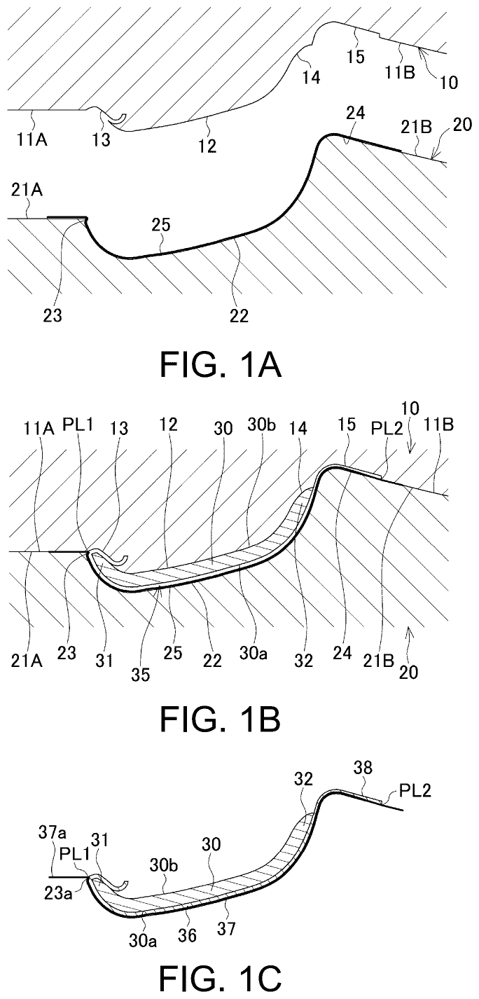

FIGS. 1A to 1C are descriptive diagrams showing an example of a method for molding a molded body according to a second configuration of the disclosure. FIG. 1A shows an upper die 10 and a lower die 20. The upper die 10 includes a pair of upper mating surfaces 11A and 11B and an inner forming surface 12 that protrudes downward, which is a mold matching direction, from the inner edge of each of the pair of upper mating surfaces 11A and 11B. On the left side of the inner forming surface 12 in FIG. 1A, a left side concave part 13 is formed for forming an inner layer and an outer layer that wrap around to the back side of a base material to be described later. On the right side of the inner forming surface 12 in FIG. 1A, a right side concave part 14 in which a right end part of the base material is disposed, and an upper excess length forming concave part 15 that extends to the right from the right side concave part 14 for forming the excess length of the inner layer and the outer layer, are formed.

The lower die 20 includes a pair of lower mating surfaces 21A and 21B and an outer forming surface 22 that is recessed downward from the inner edge of each of the pair of lower mating surfaces 21A and 21B. In the left side of the outer forming surface 22 in FIG. 1A, in the region continuous with the lower mating surface 21A, an undercut part 23 that protrudes inward is formed. In the right side of the outer forming surface 22 in FIG. 1A, in the region continuous with the lower mating surface 21B, a lower excess length forming surface 24 that opposes the upper excess length forming concave part 15 of the upper die 10 is formed.

When performing in-mold coating to form an inner layer of urethane and an outer layer of a coating material on the surface of the base material using the upper die 10 and the lower die 20, first, as shown in FIG. 1A, a coating material 25, for example a urethane-based coating material, is applied to the lower mating surface 21A and 21B and the outer forming surface 22 of the lower die 20.

Next, as shown in FIG. 1B, a base material 30 is attached to the inner forming surface 12 of the upper die 10. The base material 30 is previously formed of a resin material such as PP or ABS. Also, the base material 30 is a plate body with a trapezoidal cross section in which one side becomes a convex surface 30a and the other side becomes a concave surface 30b. Then, the concave surface 30b, which becomes the back surface of the base material 30, is attached to the inner forming surface 12.

Thus, the upper die 10 with the base material 30 attached is mold matched with the lower die 20 and mold clamping is performed. Then, a cavity 35 is formed between the upper die 10 and the lower die 20 below the base material 30. The cavity 35, at a left end part 31 side of the base material 30, is continuous with the left side concave part 13 of the upper die 10. At a right end part 32 side of the base material 30, the cavity 35 is continuous with the upper excess length forming concave part 15 of the upper die 10.

In this state, a urethane raw liquid is injection molded into the cavity 35, for example by RIM molding etc., and after hardening, demolding is performed. Then, as shown in FIG. 1C, an inner layer 36 made of urethane and an outer layer 37 formed by transfer of the coating material 25 are formed on the convex surface 30a of the base material 30. Even if there is an undercut part 23 on the left side of the lower die 20, since the inner layer 36 is made of urethane, at the time of demolding, the inner layer 36 deforms to avoid interference with the undercut part 23. The left end part 31 of the base material 30 also has a shape or thickness that does not interfere with the undercut part 23.

At the left end part 31 of the base material 30 that has been demolded, the inner layer 36 is formed by wrapping around to the back side. In addition, an excess length 37a of the outer layer 37 protrudes from a left parting line PL1. The excess length 37a protrudes from the end part on the concave surface 30b side of an undercut part 23a formed in the inner layer 36 and the outer layer 37 by the undercut part 23.

On the other hand, at the right end part 32 of the base material 30, an excess length 38 of the inner layer 36 and the outer layer 37 formed between the upper excess length forming concave part 15 and the lower excess length forming surface 24 protrudes from the base material 30. A right side parting line PL2 is formed at the position of the end part of the inner layer 36 in the excess length 38, and merely the outer layer 37 further protrudes.

Therefore, at the left end part 31, the excess length 37a of the outer layer 37 is cut off at the parting line PL1. Alternatively, the excess length 37a is cut short at a position that becomes a predetermined position on the lower mating surface 21A, and the remaining excess length 37a is folded back to the back side and adhered to the inner layer 36.

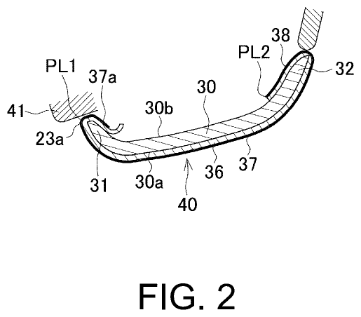

On the other hand, at the right end part 32, the outer layer 37 of the excess length 38 is cut off at the position of the parting line PL2, and the remaining excess length 38 is folded back to the back side and adhered to the base material 30. Then, as shown in FIG. 2, a molded body 40 is obtained in which the surface on the convex surface 30a side of the base material 30, the back side of the left end part 31, and the back side of the right end part 32 are covered with the inner layer 36 and the outer layer 37.

The molded body 40 is attached to the attachment target member 41 with the convex surface 30a facing outward (downward in FIG. 2) in a state where both ends are in contact with or close to the attachment target member 41. FIG. 2 shows an example in which the left side excess length 37a is folded back to the inner side and adhered to the inner layer 36. At this time, even if the excess length 37a is cut off at the parting line PL1, at the left end part, since the parting line PL1 is positioned between the left end part and the attachment target member 41, the parting line PL1 is not exposed to the outside. Also, at the right end part, the parting line PL2 is hidden on the back side. Therefore, the parting line PL2 is not exposed to the outside. Consequently, even if burrs occur at the parting line PL1 and parting line PL2, there is no need to remove the burrs. Alternatively, even if burr treatment is performed on the parting line PL1 and parting line PL2, the finishing level can be simplified.

In this way, the molded body 40 according to a first configuration includes the plate-like base material 30 which is formed of a resin material and in which one surface in the thickness direction is the convex surface 30a and the other surface is the concave surface 30b, the inner layer 36 which is formed of urethane as an example of a second resin material and covers at least the convex surface 30a of the base material 30, and the outer layer 37 which is formed of the coating material 25 as an example of a third resin material and covers at least the coating region of the convex surface 30a of the inner layer 36, and is attached to the attachment target member 41 with the convex surface 30a facing outward.

And, among the left end part 31 and the right end part 32 as an example of both end parts of the base material 30 in a direction intersecting with the thickness direction, at the left end part 31 as an example of either one end part, the undercut part 23a by injection molding is formed in the inner layer 36 covering the left end part 31. The outer layer 37 covers at least up to the undercut part 23a.

Therefore, even if the outer layer 37 by the coating material 25 is formed on the surface by in-mold coating, deterioration of appearance due to the parting line PL1 may be prevented and designability may be improved. In addition, since the coating material 25 merely needs to be applied to the lower die 20, the manufacturing process can be shortened and cost can be reduced.

The parting line PL1 is formed at the end part on the concave surface 30b side of the undercut part 23a in the inner layer 36, and the outer layer 37 covers up to the position of the parting line PL1.

Therefore, the parting line PL1 becomes positioned close to the back side of the molded body 40, and is therefore less noticeable.

The parting line PL1 is in a position at which the parting line PL1 is hidden by the attachment target member 41 when attached to the attachment target member 41.

Therefore, even if burrs occur at the parting line PL1, burr treatment is unneeded or the finishing level of burr treatment can be simplified. As a result, the manufacturing process can be shortened.

The inner layer 36, as an example of the other end part of the base material 30, which covers the right end part 32 of the base material 30, is folded toward the concave surface 30b side of the base material 30 and covers the concave surface 30b. Also, at the end part of the inner layer 36 covering the concave surface 30b, the parting line PL2 as an example of a second parting line is formed. Furthermore, the outer layer 37 is also folded toward the concave surface 30b side of the base material 30 and covers the concave surface 30b up to the position of the parting line PL2.

Therefore, even without providing the undercut part 23 in the lower die 20 like at the left end part 31 and shifting the parting line PL1 toward the concave surface 30b side, the parting line PL2 can be hidden to the back side.

In this way, the method for molding the molded body 40 according to the second configuration uses the upper die 10 as an example of a first mold having the pair of upper mating surfaces 11A and 11B as an example of first mating surfaces, and the inner forming surface 12 that protrudes in the mold matching direction from the inner edges of the pair of upper mating surfaces 11A and 11B as an example of first inner edges, and becomes an outer surface corresponding to the concave surface of the molded body 40, and the lower die 20 as an example of a second mold having the pair of lower mating surfaces 21A and 21B as an example of second mating surfaces disposed to face the pair of upper mating surfaces 11A and 11B in the mold matching direction, and the outer forming surface 22 that is recessed in the mold matching direction from the inner edges of the pair of lower mating surfaces 21A and 21B as an example of second inner edges, and becomes an outer surface corresponding to the convex surface of the molded body 40.

Then, the coating material 54 as an example of an outer resin material is applied to the outer forming surface 22 of the lower die 20, and
in a state where the plate-shaped base material 30 formed of a resin material, with the outer forming surface 22 side being the convex surface 30a and the inner forming surface 12 side being the concave surface 30b, is fixed to the inner forming surface 12 of the upper die 10, the upper die 10 and the lower die 20 are mold clamped, and urethane as an example of an inner resin material is injected into the cavity 35 formed between the inner forming surface 12 and the outer forming surface 22, to form the molded body 40 in which the inner layer 36 made of urethane and the outer layer 37 made of the coating material 54 cover the convex surface 30a of the base material 30.

Furthermore, in the molding method, a predetermined region that is continuous with the inner edge at the lower mating surface 21A side as an example of either one of the second mating surface sides in the outer forming surface 22 becomes the undercut part 23 that protrudes toward the cavity 35 side,
in the process of applying the coating material 54 to the outer forming surface 22, the coating material 54 is applied to the outer forming surface 22 including the undercut part 23, and to the lower mating surface 21A continuous with the undercut part 23, and
after the molded body 40 is taken out from the cavity 35, the outer layer 37 is cut off at the position of the inner edge or at a predetermined position of the lower mating surface 21A continuous with the inner edge.

According to the method, even if the outer layer 37 by the coating material 25 is formed on the surface by in-mold coating, deterioration of appearance due to the parting line PL1 may be prevented and designability may be improved. In addition, since the coating material 25 merely needs to be applied to the lower die 20, the manufacturing process can be shortened and cost can be reduced.

In particular, on the upper mating surface 11B side opposite to the undercut part 23 in the inner forming surface 12, the upper excess length forming concave part 15 as an example of a first excess length forming part is formed, which extends beyond the formation region of the cavity 35 and continues to the inner edge, and in the inner forming surface 12, the right side concave part 14 as an example of a concave part is formed in which the end part of the base material 30 is disposed to form the end part of the cavity 35, and
on the lower mating surface 21B side opposite to the undercut part 23 in the outer forming surface 22, the lower excess length forming surface 24 as an example of a second excess length forming part is formed, which extends beyond the formation region of the cavity 35, continues to the inner edge, and faces the upper excess length forming concave part 15,
in the process of applying the coating material 25 to the outer forming surface 22, the coating material 25 is also applied to the lower excess length forming surface 24, and

After the molded body 40 is taken out from the cavity 35, an example of the excess length 38 of the end parts of the inner layer 36 and the outer layer 37 at the first excess length forming part side and at the second excess length forming part side is folded back to the concave surface 30b side of the base material 30 and fixed to the concave surface 30b.

Therefore, at the right side of the base material 30, the parting line PL2 can be hidden at a position unable to be seen from the outside.

The following describes modified examples of the disclosure.

The undercut part formed in the inner layer may also be provided at the end part on the opposite side of the above embodiment. The region and angle of the undercut part can be appropriately modified.

For example, the shape and thickness of the base material are not limited to the above embodiment. For example, the base material may have a shape such as an arc-shaped cross section or circular cross section, or triangular cross section, instead of a trapezoidal cross section. The base material may be one in which thin-walled parts and thick-walled parts coexist. The base material may have protruding parts as long as the base material can be molded with two molds.

The shapes of the first mold and the second mold can also be modified. For example, the upper die and the lower die of the above embodiment may be inverted, the coating material may be applied to the outer forming surface provided on the upper die, and the base material may be fixed to the inner forming surface provided on the lower die to perform molding.

The disposition of the two molds is not limited to upper and lower, but may also be left and right.

What is claimed is:

1. A molded body, comprising: a plate-shaped base material, formed of a resin material, with one surface in a thickness direction being a convex surface and the other surface being a concave surface; an inner layer, formed of a second resin material and covering at least the convex surface of the base material; and an outer layer, formed of a third resin material and covering at least a coating region of the convex surface of the inner layer, and the molded body being attached to an attachment target member with the convex surface facing outward,
at either one of both end parts of the base material in a direction intersecting with the thickness direction, an undercut part being formed by injection molding in the inner layer covering the end part, and
the outer layer covering at least up to the undercut part.

2. The molded body according to claim 1, wherein a parting line is formed at an end part on the concave surface side of the undercut part in the inner layer, and the outer layer covers up to a position of the parting line.

3. The molded body according to claim 2, wherein the parting line is positioned to be hidden by the attachment target member when attached to the attachment target member.

4. The molded body according to claim 2, wherein the inner layer covering the other end part of the base material is folded toward the concave surface side of the base material and covers the concave surface, a second parting line is formed at an end part of the inner layer covering the concave surface, and the outer layer is also folded toward the concave surface side of the base material and covers the concave surface up to a position of the second parting line.

5. A method for molding a molded body, comprising: using a first mold having a pair of first mating surfaces and an inner forming surface that protrudes in a mold matching direction from first inner edges of the pair of first mating surfaces and becomes an outer surface corresponding to a concave surface of the molded body, and
a second mold having a pair of second mating surfaces disposed to face the pair of first mating surfaces in the mold matching direction and an outer forming surface that is recessed in the mold matching direction from second inner edges of the pair of second mating surfaces and becomes an outer surface corresponding to a convex surface of the molded body;
applying an outer resin material to the outer forming surface of the second mold; and
in a state where a plate-shaped base material formed of a resin material, with the outer forming surface side being a convex surface and the inner forming surface side is a concave surface, is fixed to the inner forming surface of the first mold, mold clamping the first mold and the second mold and injecting an inner resin material into a cavity formed between the inner forming surface and the outer forming surface to form a molded body in which an inner layer made of the inner resin material and an outer layer made of the outer resin material cover the convex surface of the base material, wherein
a predetermined region continuous with the second inner edge on either one of the second mating surface sides of the outer forming surface becomes an undercut part that protrudes toward the cavity side,
in a process of applying the outer resin material to the outer forming surface, the outer resin material is applied to the outer forming surface including the undercut part and to the one of the second mating surfaces continuous with the undercut part, and
after the molded body is taken out from the cavity, the outer layer is cut off at a position of the second inner edge or at a predetermined position of the one of the second mating surfaces continuous with the second inner edge.

6. The method for molding the molded body according to claim 5, wherein on the first mating surface side opposite to the undercut part in the inner forming surface, a first excess length forming part which extends beyond a formation region of the cavity and continues to the first inner edge is formed, and in the inner forming surface, a concave part in which an end part of the base material is disposed to form an end part of the cavity is formed,
on the second mating surface side opposite to the undercut part in the outer forming surface, a second excess length forming part which extends beyond the formation region of the cavity, continues to the second inner edge, and faces the first excess length forming part is formed,
in the process of applying the outer resin material to the outer forming surface, the outer resin material is also applied to the second excess length forming part, and
after the molded body is taken out from the cavity, end parts of the inner layer and the outer layer at the first excess length forming part side and at the second excess length forming part side are folded back to the concave surface side of the base material and fixed to the concave surface.
